(19) United States
(12) Patent Application Publication
(10) Pub. No.: US 2011/0010529 A1
(43) Pub. Date: Jan. 13, 2011

(54) INSTRUCTION EXECUTION CONTROL METHOD, INSTRUCTION FORMAT, AND PROCESSOR

(75) Inventor: Masayuki Yamasaki, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/885,891

(22) Filed: Sep. 20, 2010

Related U.S. Application Data
(63) Continuation of application No. PCT/JP2009/001086, filed on Mar. 11, 2009.

(30) Foreign Application Priority Data
Mar. 28, 2008 (JP) 2008-088098

(51) Int. Cl. G06F 9/30

(52) U.S. Cl. 712/220; 712/E09.016

(57) ABSTRACT

With conventional ordered data reference instructions, an instruction which is to be the subject of an execution order guarantee cannot be separately specified, and a resource which is to be the subject of an execution order guarantee likewise cannot be specified and thus instruction movement is restricted more than necessary in the out-of-order execution of instructions and so on and performance deterioration becomes significant particularly in the case of performing data transfer to a resource having high access latency. Consequently, the field of an ordered data reference instruction judged to include a predetermined field is decoded so as to identify a subject instruction which is specified by the ordered data reference instruction and is the subject of execution order guarantee, and guarantee the execution order of the subject instruction with respect to the execution of the identified ordered data reference instruction.

### CROSS REFERENCE TO RELATED APPLICATION(S)

This is a continuation application of PCT application No. PCT/JP2009/001086 filed Mar. 11, 2009, designating the United States of America.

### BACKGROUND OF THE INVENTION

(1) Field of the Invention

The present invention relates to an instruction execution control method, an instruction format, and a processor using the instruction execution control method.

(2) Description of the Related Art

Ordered data reference instructions, instruction formats for the ordered data reference instructions, and processors which execute instructions of ordered data reference instructions are conventionally available.

There are instances in which the execution order of instructions is changed due to out-of-order execution of instructions or the optimization of a compiler.

On the other hand, when the execution order of instructions is unintentionally changed, there are cases where trouble occurs because the execution order of instructions prior to changing cannot be followed. For example, when exchanging of data is performed between a processor and a memory outside the processor or an IO (Input/Output) register, or when queuing with another processor is necessary, or when an IO register has to perform reading after another IO register completes writing, and so on, there are instances in which trouble occurs when the execution order of instructions is unintentionally changed. In general, when there is a dependence relationship between two instructions, such as what is called data dependence (flow dependence, inverse dependence, output dependence, and so on), control dependence, resource conflict, and so on, or a causal relationship between such instructions, there is the possibility that a problem will occur when the execution order of such instructions is unintentionally changed.

Consequently, as a conventional method for solving such problem, ordered data reference instructions are prepared in IA-64 PROCESSOR KIHON KOHZA (IA-64 Processor Fundamental Course) (description on pages 77 to 79); Author: Mitsuru IKEI; Publisher: Ohmsha Ltd.; published: Aug. 25, 2000 (Non-Patent Reference 1).

With the conventional ordered data reference instructions disclosed in Non-Patent Reference 1, three types of instructions, namely, an acquire instruction, a release instruction, and a fence instruction, are prepared so that the data reference instructions are executed in an IA-64 processor, according to the order intended by a program. (a) An acquire instruction is an ordered data reference instruction which causes guaranteeing that, after the execution of the acquire instruction is completed, the data reference instruction inscribed after such acquire instruction is executed. (b) A release instruction is an ordered data reference instruction which causes guaranteeing that, before execution of the release instruction, the execution of the data reference instruction inscribed ahead of such release instruction is completed. (c) A fence instruction is an ordered data reference instruction which causes guaranteeing that, after the execution of the fence instruction is completed, the data reference instruction inscribed after such fence instruction is executed, and causes guaranteeing that, before execution of the fence instruction, the execution of the data reference instruction inscribed ahead of such fence instruction is completed.

Non-Patent Reference 1 discloses a technique, such as that described above, which provides ordered data reference instructions which cause execution order of other data reference instructions to be guaranteed.

### SUMMARY OF THE INVENTION

However, with the above-described conventional technique, it is not possible to separately specify an instruction which is the subject of an execution order guarantee, and it is not possible to specify a resource which is the subject of an execution order guarantee, and thus the execution order of many instructions are unconditionally guaranteed. As such, the instructions whose execution order is guaranteed by the ordered data reference instructions become numerous, and there is the problem that the speed of the processor deteriorates and performance deterioration increases in the case where instruction movement is unnecessarily restricted during out-of-order execution of instructions, and so on, and data transfer particularly to a resource having high access latency is performed, and so on.

The present invention is conceived in view of such problem and has as an object to enable the speed of a processor to be increased by limiting the instructions which are to be the subject of an execution order guarantee to only appropriate instructions.

The instruction execution control method, instruction format, and processor according to the present invention which solve the aforementioned problem are described below.

The instruction execution control method according to a first aspect of the present invention is an instruction execution control method of controlling execution of an instruction by a processor, the method including: judging whether or not a field, which is predetermined, is included in a first data reference instruction; identifying a second data reference instruction specified by the first data reference instruction and which is to be a subject of an execution order guarantee, by decoding the field of the first data reference instruction that is judged to include the field in the judging; and controlling an execution order of the first data reference instruction and the second data reference instruction during execution of the first data reference instruction and the second data reference instruction, so as to guarantee the execution order of the identified second data reference instruction with respect to the execution of the first data reference instruction.

Furthermore, according to a second aspect of the present invention, in the identifying, a second data reference instruction inscribed after the first data reference instruction and specified by the first data reference instruction may be identified by decoding the field of the first data reference instruction that is judged to include the field in the judging, the second data reference instruction being the subject of the execution order guarantee, and in the controlling, the second data reference instruction identified may be caused to be executed in an execution order that is after completion of the execution of the first data reference instruction.

Furthermore, according to a third aspect of the present invention, in the identifying, a second data reference instruction inscribed ahead of the first data reference instruction and specified by the first data reference instruction may be identified by decoding the field of the first data reference instruction that is judged to include the field in the judging, the second data reference instruction being the subject of the execution order guarantee, and in the controlling, the second data reference instruction identified may be caused to be executed in an execution order in which completion of execution of the second data reference instruction is ahead of the execution of the first data reference instruction.

Furthermore, the non-transitory computer-readable recording medium according to a tenth aspect of the present invention is a non-transitory computer-readable recording medium on which a data reference instruction is recorded, wherein the data reference instruction includes: an instruction main portion which identifies a resource that is an access destination of the data reference instruction; and a field which indicates whether or not the data reference instruction is an ordered data reference instruction that causes an execution order of another data reference instruction to be guaranteed.

In this manner, the format (instruction format) of the data reference instruction recorded on the non-transitory computer-readable recording medium is a format which includes the instruction main portion and the field.

In this manner, the data reference instruction to which the appropriate instruction format is applied may be recorded on the non-transitory computer-readable recording medium, and more specifically, for example, a computer program including the data reference instruction may be recorded on the non-transitory computer-readable recording medium.

Furthermore, the non-transitory computer-readable recording medium according to an eleventh aspect of the present invention is a non-transitory computer-readable recording medium on which a data reference instruction is recorded, wherein the data reference instruction includes a field which identifies a subject data reference instruction for which a relative execution order with respect to the data reference instruction is guaranteed, the guarantee being caused by the data reference instruction.

Accordingly, it is possible to separately specify an instruction that is to be the subject of an execution order guarantee, and thus, during out-of-order execution for example, instructions that cannot be moved are limited to those appropriate instructions that have been specified. By reducing the instructions for which movement is to be restricted, it becomes possible to more freely move instruction and, for example, by being able to sufficiently reduce stalling, and so on, the execution speed of a processor can be increased.

It is to be noted that “to guarantee the execution order of the identified second data reference instruction with respect to the execution of the first data reference instruction” described previously means guaranteeing an execution order relative to the execution of the first data reference instruction, and means, for example, guaranteeing an execution order relative to a predetermined reference time within an execution time from the start of the execution of the first data reference instruction in its own execution order up to completion.

Furthermore, according to a fifth aspect of the present invention, the field may indicate whether or not the first data reference instruction specifies the second data reference instruction, and in the identifying, when the specifying is indicated, another data reference instruction whose access destination is a same resource as a resource which is an access destination of the first data reference instruction may be identified as the second data reference instruction specified.

Accordingly, since the instruction which is to be the subject of the execution order guarantee is determined according to the resource which is the access destination of an ordered data reference instruction, a dedicated field for specifying the instruction which is to be the subject of the execution order guarantee becomes unnecessary and it becomes possible to configure an ordered data reference instruction having no dedicated field. Therefore, an ordered data reference instruction can be configured freely and the range of applications of the ordered data reference instruction is broadened.

Furthermore, according to a ninth aspect of the present invention, the field may identify a data reference instruction, and in the identifying, the data reference instruction identified by the field may be identified as the second data reference instruction by decoding the field.

Accordingly, since the instruction which is to be the subject of the execution order guarantee is determined according to the specification by the field of the ordered data reference instruction, the instruction which is to be the subject of the execution order guarantee can be selected easily, freely, and appropriately, and, even with respect to the same instruction which is to be the subject of the execution order guarantee, the method for specifying such instruction can be freely selected, and thus the freedom in specifying the instruction which is to be the subject of the execution order guarantee is broadened. Furthermore, it becomes possible for the processor to easily identify the instruction which is to be the subject of the execution order guarantee based simply on the specification in the field.

The present invention can improve the executing capability of a processor by reducing the instructions for which movement is to be restricted, by limiting subject instructions which are to be the subject of an execution order guarantee to only specified appropriate instructions.

### FURTHER INFORMATION ABOUT TECHNICAL BACKGROUND TO THIS APPLICATION

The disclosure of Japanese Patent Application No. 2008-088098 filed on Mar. 28, 2008 including specification, drawings and claims is incorporated herein by reference in its entirety.

The disclosure of PCT application No. PCT/JP2009/001086 filed on Mar. 11, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing personal computer (PC) including a processor and a program executed by the personal computer;

FIG. 2 is a diagram showing a specific configuration of an executing unit, and an instruction issuing unit and a data storage unit which are connected to the executing unit;

FIG. 3 is a diagram showing a specific configuration of the instruction issuing unit, and an instruction storage unit and the executing unit which are connected to the instruction issuing unit;

FIGS. 4A, 4B, and 4C are diagrams showing instruction formats of an ordered data reference instruction;

FIGS. 5A and 5B are diagrams showing a program including three specific examples, first to third, of a first-model ordered data reference instruction, and respective resources on which resource access is performed according to the respective specific examples of the first-model ordered data reference instruction;

FIGS. 6A, 6B, 6C, and 6D are diagrams showing four programs in which one of the first through fourth specific examples of the second-model ordered data reference instructions are included, and the data storage unit and IO register which are resource-accessed according to such specific examples;

FIG. 7 is a diagram for describing the program including a first-type ordered data reference instruction;

FIG. 8 is a diagram for describing the program including a second-type ordered data reference instruction;

FIG. 9 is a diagram for describing the program including a third-type ordered data reference instruction;

FIG. 10 is a flowchart showing the process in the execution of instructions by the PC;

FIG. 11 is a flowchart showing specific details of step S4 in FIG. 10; and

FIG. 12 is a flow chart showing specific details of step S44 in FIG. 11.

### DESCRIPTION OF THE PREFERRED EMBODIMENT(S)

Hereinafter, an embodiment of a method, an instruction format, and a processor according to the present invention shall be described with reference to the Drawings.

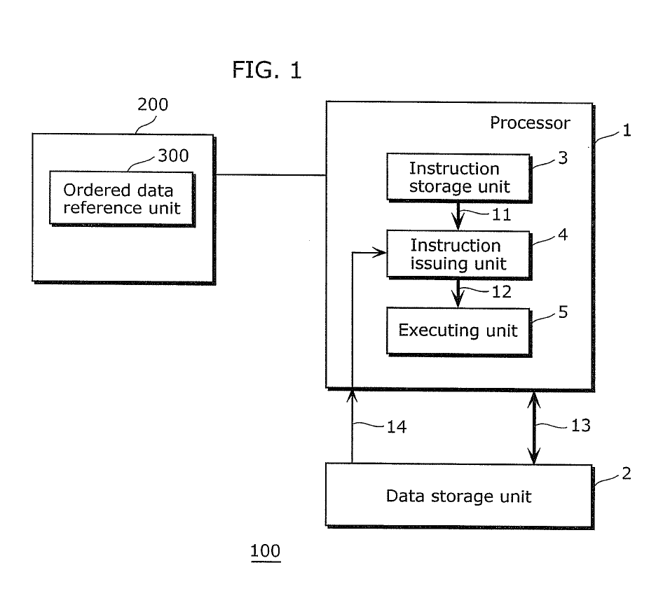

FIG. 1 is a diagram showing a personal computer 100 including a processor 1, and a program 200 executed by the personal computer 100. The personal computer 100 shall be denoted as PC 100 hereafter.

The PC 100 includes the processor 1 and a data storage unit 2.

The processor 1 is a processor (Central Processing Unit: CPU) which executes the program 200 held by the PC 100. It is to be noted that the program 200 in the present embodiment includes an ordered data reference instruction 300, and the processor 1 has an instruction set which includes the ordered data reference instruction 300.

The data storage unit 2, which is used by the processor 1 for storing data, holds the data stored therein by the processor 1 and transmits stored data to the processor 1. For example, the data storage unit 2 is a main memory or a hard disk (HDD) of the PC 100.

The processor 1 includes an instruction storage unit 3, an instruction issuing unit 4, and an executing unit 5.

The instruction storage unit 3 receives and stores the program 200 that is inputted to the processor 1. The instruction storage unit 3 is, for example, an instruction cache provided in the processor 1.

The instruction issuing unit 4 obtains, from the instruction storage unit 3, an execution portion to be currently executed by the processor 1 out of the program 200 stored in the instruction storage unit 3, issues respective instructions included in the obtained execution portion to the executing unit 5 and causes the execution unit 5 to execute the respective instructions. At this time, the instruction issuing unit 4 issues instructions out-of-order, that is, issues instructions randomly, arbitrarily moving the original order of the respective instructions in the program 200 to another order, and causing the executing unit 5 to execute the respective instructions according to the moved execution order. It is to be noted that the instruction issuing unit 4 obtains the execution portion from the instruction storage unit 3 via a data line 11.

In addition, when causing the execution of an instruction for performing a resource access such as writing into or reading from the data storage unit 2, the instruction issuing unit 4 performs a completion-detection for the completion of the resource access by obtaining, from the data storage unit 2 via a signal line 14, a completion signal indicating the completion of such resource accesses.

It is to be noted that, resource accesses include a resource access in which writing of data to the accessed resource or input of data to the resource is performed, a resource access in which reading of data from the accessed resource or output of data from the resource is performed, and a resource access in which a combination of both the writing or input and the reading or output is performed. Such resource access is performed, for example, via a signal line 13.

The executing unit 5 executes the respective instructions issued by the instruction issuing unit 4 for execution by the executing unit 5. The executing unit 5 executes the respective instructions according to the execution order in which the instruction issuing unit 4 causes the executing unit 5 to perform the execution. When the instruction to be executed is an instruction for resource access in the data storage unit 2, the executing unit 5 causes the storing of data into the data storage unit 2, obtains the stored data, and so on. It is to be noted that the executing unit 5 obtains the issued instructions from the instruction issuing unit 4 via a data line 12, and executes the obtained instructions.

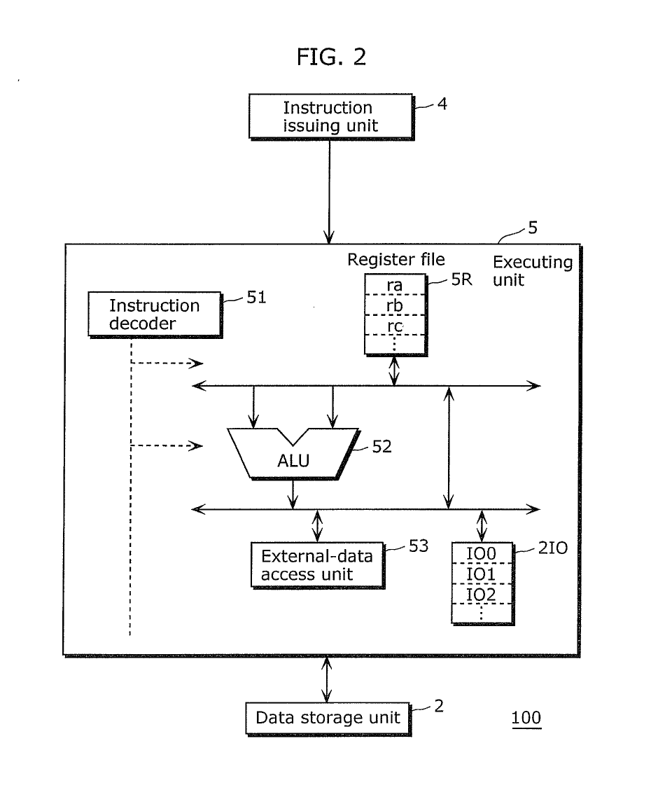

FIG. 2 is a diagram showing a specific configuration of the executing unit 5 and the instruction issuing unit 4 and the data storage unit 2 which are connected to the executing unit 5.

The executing unit 5 includes an instruction decoder 51, an Arithmetic Logic Unit (ALU) 52, an external-data access unit 53, an IO register 2IO, and a register file 5R. Furthermore, the executing unit 5 includes a bus which connects each of these constituent elements, and a control signal line which connects the instruction decoder 51 and other constituent elements.

The instruction decoder 51 decodes an instruction to be executed by the executing unit 5, and outputs, to the other constituent elements of the executing unit 5, a control signal corresponding to the details of the instruction identified through the decoding. The executing unit 5 controls the respective constituent elements according to the details of the instruction by causing the instruction decoder 51 to decode the instruction to be executed and causing the instruction decoder 51 to input the control signal corresponding to the details of such instruction to the respective constituent elements. The executing unit 5 executes the instruction by controlling the operation of the respective constituent elements in the above manner.

It is to be noted that the instruction issuing unit 4 may also decode at least part of an instruction in order to obtain an instruction required for issuing the respective instructions in the appropriate order.

The ALU 52 is an arithmetic unit which, in the case where the details of the instruction is an arithmetic operation on the data, the executing unit 5 causes to perform such arithmetic operation. The instructions for an arithmetic operation by the executing unit 5 using the ALU 52 include operation such as addition, subtraction, multiplication, and division. As with an instruction for arithmetic operations such as addition, subtraction, multiplication, and division, the instructions include an instruction for performing arithmetic operation based on plural data (polynomial arithmetic instruction). The instruction based on plural data includes operands each of which identifies the respective data which is the basis of the instruction.

The external-data access unit 53 performs resource access to the data storage unit 2. When the executing unit 5 executes an instruction for a resource access to the data storage unit 2, the resource access is performed by the external-data access unit 53.

The IO register 2IO is a register provided in the executing unit 5 for I/O (Input/Output). When the instruction to be executed involves I/O, the executing unit 5 executes the instruction by performing a resource access to the IO register 2IO. The IO register 2IO is configured of a collection of individual registers such as an individual register IO0, an individual register IO1, an individual register IO2, and the like.

It is to be noted that each of the data storage unit 2 and the IO register 2IO corresponds to an example of a resource which is an access destination on which the executing unit 5 performs a resource access (writing and reading).

The register file 5R is a high-speed memory device (collection of registers) for temporarily storing data. The executing unit 5 writes data into the register file 5R or reads data from the register file 5R depending on the executed instruction. Even in the case where the instruction has an operand according to the register indirect mode, the executing unit 5 reads data from the register file 5R, and executes processing based on data of a data region identified by the read data. The data read from the register file 5R at this time is a pointer which identifies the data region in which data that is the basis of the processing is stored.

It is to be noted that the instruction issuing unit 4 issues instructions out of order in accordance with the specific configuration of the executing unit 5. For example, when, after issuing an instruction that causes writing to the external-data access unit 53, an instruction that causes reading of the written data is to be issued, the instruction issuing unit 4 moves an instruction, which causes only the ALU 52 and so on to operate but causes the external-data access unit 53 not to operate, to an execution order that is in-between the start and the completion of the writing, and issues, in such execution order, the instruction which causes only the ALU 52 and so on to operate. In addition, the instruction issuing unit 4 moves the instruction for the reading to an execution order that is after the completion of the writing and issues the instruction for the reading in such execution order.

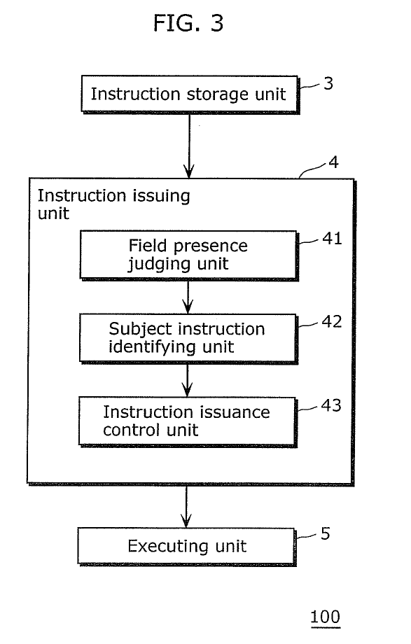

FIG. 3 is a diagram showing a specific configuration of the instruction issuing unit 4, and the instruction storage unit 3 and the executing unit 5 which are connected to the instruction issuing unit 4. Based on the ordered data reference instruction 300 included in the program 200, the instruction issuing unit 4 in the present embodiment can more freely perform the moving of instructions and can increase the speed of the execution of the program 200 by the processor 1. This point is described in detail in the subsequent description.

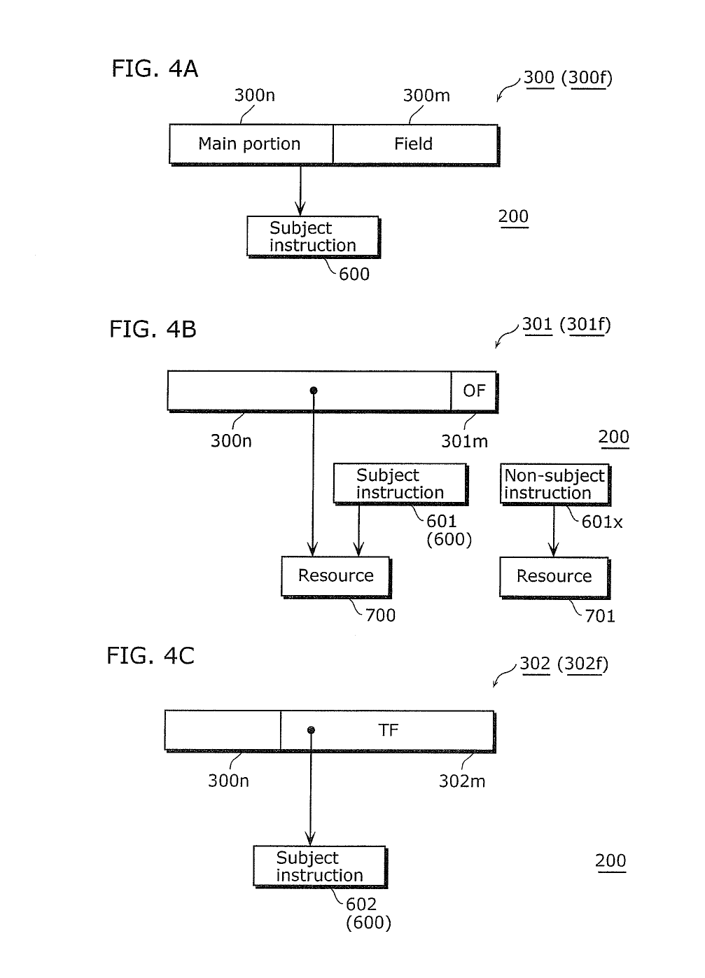

FIGS. 4A to 4C are diagrams showing an instruction format 300f of the ordered data reference instruction 300.

FIG. 4A is a diagram showing a schematic structure of the ordered data reference instruction 300.

The ordered data reference instruction 300 includes a main portion 300n and a field 300m.

The main portion 300n is data for identifying the execution contents that the ordered data reference instruction 300 causes the executing unit 5 to execute, and includes an operation code identifying the type of processing such as an arithmetic operation of adding, data writing into the data storage unit 2, and so on, and an operand identifying the data region of data to be processed. It is to be noted that, in the case where the ordered data reference instruction 300 is a polynomial arithmetic instruction such as an instruction for arithmetic operations of addition, subtraction, multiplication, and division, the main portion 300n includes plural operands.

The field 300m is data which, by being decoded, allows for the obtainment of information needed in identifying a subject instruction 600 which is specified by the ordered data reference instruction 300 as the subject instruction which is the subject of an execution order guarantee. It is to be noted that a specific structure of the field 300m shall be described later with reference to FIGS. 4A and 4B.

As shown in FIG. 3, the instruction issuing unit 4 includes a field presence judging unit 41, a subject instruction identifying unit 42, and an instruction issuance control unit 43.

The field presence judging unit 41 judges whether or not the field 300 is included in an instruction. The field presence judging unit 41 identifies such instruction as the ordered data reference instruction 300 when it judges that the field 300 is present, and identifies such instruction as a general instruction which is not the ordered data reference instruction 300 when it judges that the field 300 is not present.

The subject instruction identifying unit 42 decodes the field 300m of the instruction which includes the field 300m according to the judgment by the field presence judging unit 41, and identifies the subject instruction 600 specified by the ordered data reference instruction 300 (FIG. 4A).

The instruction issuance control unit 43 (FIG. 3) arbitrarily changes the order of instructions, from the original order of the instructions in the program 200 to another order, issues the respective instructions to the executing unit 5 according to the changed issuing order, and causes the executing unit 5 to execute the respective instructions according to an execution order that is the same as the issuing order in which the issuance was performed. For example, the instruction issuance control unit 43 causes the executing unit 5 to execute an instruction by inputting a signal representing the details of such instruction to the executing unit 5.

In addition, when there is an ordered data reference instruction 300, the instruction issuance control unit 43 guarantees for a certain range a relative execution order of the subject instruction 600 specified by the ordered data reference instruction 300, with respect to the execution of the ordered data reference instruction 300.

The specific structure of the field 300m and the manner in which the subject instruction identifying unit 42 processes such structure shall be described hereafter. The ordered data reference instruction 300 includes a first-model ordered data reference instruction 301 (FIG. 4B) and a second-model ordered data reference instruction 302 (FIG. 4C).

FIG. 4B is a diagram showing the first-model ordered data reference instruction 301.

In the first-model ordered data reference instruction 301, the field 300m is a specification presence display field 301m which indicates whether or not the first-model ordered data reference instruction 301 specifies a subject instruction 600. In the case where the specification presence display field 301m indicates that the first-model ordered data reference instruction 301 specifies a subject instruction 600, the first-model ordered data reference instruction 301 identifies the subject instruction 600 through the main portion 300n. Specifically, in this case, based on a resource 700 (FIG. 4B) which is identified by the main portion 300n and is the access destination on which a resource access by the first-model ordered data reference instruction 301 is to be performed, the first-model ordered data reference instruction 301 specifies, as a subject instruction 601, another data reference instruction that has, as an access destination, a resource 700 that is the same as the resource 700. Therefore, the first-model ordered data reference instruction 301 does not specify, as the subject instruction 601, a data reference instruction (non-subject instruction 601x) that has as an access destination a resource 701 which is different from the resource 700.

It is to be noted that, here, resources such as the same resource 700 and the different resource 701 include, for example, the data storage unit 2 or the IO register 2IO as described above. Moreover, the resources such as the same resource 700 and the different resource 701 may include other resources as well.

In the case where the specification presence display field 301m indicates that the first-model ordered data reference instruction 301 does not specify a subject instruction 600, the first-model ordered data reference instruction 301 becomes a data reference instruction that does not guarantee an execution order, and thus ceases to be an ordered data reference instruction in the strict sense.

In the case where the subject instruction identifying unit 42 decodes the specification presence display field 301m and judges that the first-model ordered data reference instruction 301 specifies a subject instruction, the subject instruction identifying unit 42 reads the main portion 300n and identifies the resource 700 identified by the main portion 300n, thereby identifying, as the subject instruction 601, another data reference instruction that has the same resource 700 as the identified resource 700.

FIG. 4C is a diagram showing the second-model ordered data reference instruction 302.

In the second-model ordered data reference instruction 302, the field 300m is a subject identification field 302m for identifying a subject instruction 602. The second-model ordered data reference instruction 302 specifies an instruction as the subject instruction 602 according to the subject identification field 302m, that is, it specifies, as the subject instruction 602, a data reference instruction identified by the subject identification field 302m.

The subject instruction identifying unit 42 decodes the subject identification field 302m, judges another data reference instruction identified by the subject identification field 302m, and identifies that the other data reference instruction that is judged as being identified is the subject instruction 602 specified by the second-model ordered data reference instruction 302.

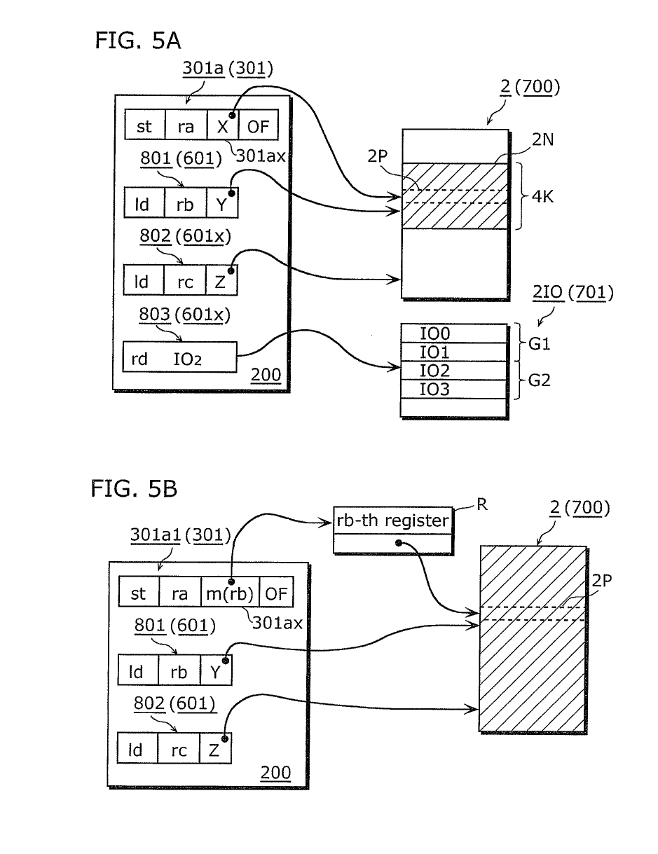

FIG. 5A is a diagram showing the program 200 including three specific examples, first to third, of the first-model ordered data reference instruction 301 (FIG. 4B), and respective resources on which resource access is performed by the specific examples of the first-model ordered data reference instruction 301.

FIG. 5A is a diagram showing the program 200 including the first specific example of a first-model ordered data reference instruction 301, the resource 700 which is to be resource-accessed by a first-model ordered data reference instruction 301a of the first specific example, and the resource 701.

The program 200 in the case of FIG. 5A includes four instructions, namely, an “st ra X OF” instruction (the first specific example of the first-model ordered data reference instruction 301a), an “Id rb Y” instruction (other data reference instruction 801, subject instruction 601), an “Id rc Z” instruction (other data reference instruction 802, non-subject instruction 601), and an “rd IO2” instruction (other data reference instruction 803, non-subject instruction 601).

As described above, in the case where the first-model ordered data reference instruction 301 specifies the subject instruction 601, the first-model ordered data reference instruction 301 identifies, as a subject instruction 601, the other data reference instruction 801 which has as an access destination a resource 700 that is the same as the resource 700 (data storage unit 2) which is the access destination identified by the main portion 300n. In addition, in the first-model ordered data reference instruction 301, the other data reference instruction 803, which has as an access destination the different resource 701 (IO register 2IO), is considered to be a non-subject instruction 601x that is not to be identified.

Moreover, out of the other data reference instructions having the access destination resource 700 as an access destination (data reference instruction 801 and data reference instruction 803), the first-model ordered data reference instruction 301 in the first specific example specifies, as the subject instruction 601, only the other data reference instruction 801 which accesses, among respective data regions included in the resource 700, a neighboring data region 2N in the neighborhood of an access location 2P of the first-model ordered data reference instruction 301 which is specified by an operand 301ax. Despite performing a resource access to the same resource 700, the other data reference instruction 802 which accesses a data region other than the neighboring data region 2N is considered to be a non-subject instruction 601x which is not a subject instruction 601.

In the first specific example, the subject instruction identifying unit 42 decodes the operand 301ax, identifies the neighboring data region 2N in the neighborhood of an access location 2P specified by the operand 301ax, and identifies, as a subject instruction 601, only the other data reference instruction 801 which accesses the identified neighboring data region 2N out of the other data reference instructions 801 and 802 which access the same resource 700.

It is to be noted that the neighboring data region 2N is a data region which has a width of 4K bytes and the access location 2P as a center.

Next, a modification of the first specific example shall be described as the second specific example. In this modification, when the access destination resource is the IO register 2IO, the first-model ordered data reference instruction 301 specifies, as a subject instruction 601, the other data reference instruction 803 which accesses the same groups G1, G2 as the groups G1, G2 . . . to which the individual register which is the access destination, among the individual registers IO0, IO1, IO2 . . . , belongs. Here, the groups to which registers included in the IO register 2IO belong are, as an Is example, groups made up of two registers with adjacent register numbers, as shown in the IO register 2IO in FIG. 5A.

In the case of the second specific example, the subject instruction identifying unit 42 (i) identifies the group to which the individual register which is accessed and which is identified by the main portion 300n of the first-model ordered data reference instruction 301, among the respective individual registers such as the individual register IO0, the individual register IO1, and the individual register IO2 which are included in the IO register 2IO, belongs, (ii) and specifies, as a subject instruction 601, the other data reference instruction which accesses an individual register included in the identified group.

Next, the third specific example shall be described. It is acceptable that the first-model ordered data reference instruction 301 specifies, as a subject instruction 601, only the other data reference instruction which accesses a same access location 2P as the access location 2P.

In the case of the third specific example, the subject instruction identifying unit 42 specifies, as a subject instruction 601, only the other data reference instruction which accesses the access location 2P. For example, as shown by the data reference instruction 801 in FIG. 5A, even when accessing the neighboring data region 2N, a data reference instruction which accesses a location other than the access location 2P out of the neighboring data region 2N is considered to be a non-subject instruction 601x, and only another data reference instruction which accesses the access location 2P is specified as a subject instruction 601.

FIG. 5B is a diagram showing the program 200 including a fourth specific example of the first-model ordered data reference instruction 301 and the resource 700 which is to be resource-accessed according to a first-model ordered data reference instruction 301a1 of the fourth specific example. The fourth specific example is a modification of the first specific example or the third specific example.

The program 200 in the case of FIG. 5B includes an “str ra m(rb) OF) instruction (first-model ordered data reference instruction 301a1 of the fourth specific example).

In the case where, according to the register indirect mode, the first-model ordered data reference instruction 301a1 shown in FIG. 5B has an operand 301ax identifying the access location 2P according to the content of a register R included in the register 5R (FIG. 2), the first-model ordered data reference instruction 301a1 specifies a subject instruction 601 in the manner described below.

In the case where, according to the register indirect mode, the first-model ordered data reference instruction 301a1 has the operand 301ax identifying the access location 2P, the first-model ordered data reference instruction 301a1 specifies, as a subject instruction 601, any data reference instruction which resource-accesses the same resource 700, even when the access location in such resource access is different from the access location 2P of the first-model ordered data reference instruction 301a1.

When the first-model ordered data reference instruction 301a1 is of the register indirect mode, the subject instruction identifying unit 42 identifies, as a subject instruction 601, any data reference instruction as long as it is a data reference instruction that performs resource-accessing on the same resource 700. In this case, for example, the subject instruction identifying unit 42 identifies, as a subject instruction 601, both the aforementioned data reference instruction 801 and the data reference instruction 802 since they are not different in terms of having the same resource 700 as an access destination.

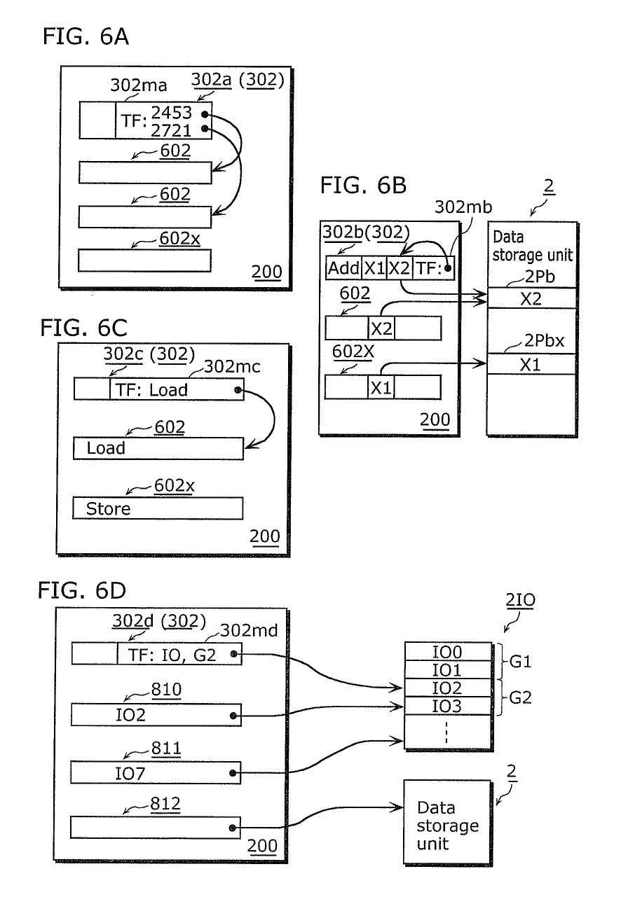

FIGS. 6A to 6D are diagrams showing four programs 200 which respectively include first to fourth specific examples of the second-model ordered data reference instruction 302 (FIG. 4C), and the data storage unit 2 and the IO register 2IO which are resource-accessed according to such specific examples.

FIG. 6A is a diagram showing the first specific example of the second-model ordered data reference instruction 302.

In a second-model ordered data reference instruction 302a according to the first specific example, a subject identification field 302ma holds the address (storage address) of a subject instruction 602 and, according to the held address, the other data reference instruction stored in the data region of such address is identified as a subject instruction 602, and the rest of the data reference instructions are considered to be non-subject instructions 602 which are not a subject instruction 602.

Here, in FIG. 6A, an example is shown where the subject identification field 302ma holds two addresses and thus identifies two subject instructions 602. The subject identification field 302ma may hold only one address and may also hold plural addresses.

It is to be noted that a stored address may be an address relative to the ordered data reference instruction 302a, or may be an address relative to the first address of the program 200, or may be an absolute address of the instruction, which is not associated with the storage position of the program 200 in the storage area in which the program 200 is stored.

In the first specific example, the subject instruction identifying unit 42 decodes the subject identification field 302ma, identifies the stored addresses, and identifies, as subject instructions 602, the other data reference instructions respectively indicated by such addresses.

FIG. 6B is a diagram showing the second specific example of the second-model ordered data reference instruction 302 and the data storage unit 2.

In a second-model ordered data reference instruction 302b according to the second specific example, a subject identification field 300mb is operand selection data for selecting an operand out of plural operands. FIG. 6B shows an example of the case where the subject identifying field 300mb selects, out of a first operand storing a value X1 and a second operand storing a value X2, only the latter second operand.

Subsequently, by selecting an operand according to the operand selection data in the above-described manner, the subject identifying field 300mb identifies, as a subject instruction 602, another data reference instruction which accesses a same access location 2Pb as the access location 2Pb of the ordered data reference instruction 302b, which is identified by the selected operand. With the subject identifying field 300mb, another data reference instruction which accesses an access location 2Pbx that is different from such access location 2Pb is considered to be a non-subject instruction 602x.

It is to be noted that the ordered data reference instruction 302b may have operand selection data for selecting two or more operands, and thus may identify plural subject instructions 602.

In the second specific example, the subject instruction identifying unit 42 decodes the subject identifying field 302mb, identifies the stored addresses, and identifies, as a subject instruction 602, the respective other data reference instructions indicated by the addresses.

FIG. 6C is a diagram showing the third specific example of the second-model ordered data reference instruction 302.

In a second-model ordered data reference instruction 302c according to the third specific example, a subject identifying field 302mc holds the operation code of the instruction and identifies, as a subject instruction 602, another data reference instruction having the same operation code as the stored operation code, and another data reference instruction having a different operation code is considered to be non-subject instructions 602x. It is to be noted that FIG. 6C shows an example of the case where the subject identifying field 302mc stores the operation code of a Load instruction and identifies only the data reference instruction which is a Load instruction out of the other data reference instructions, and does not identify the data reference instruction that is a Store instruction.

Moreover, the subject identifying field 302mc may store plural operation codes and identify, as subject instructions 602, all of the other data reference instructions having one of such plural operation codes.

In the third specific example, the subject instruction identifying unit 42 decodes the subject identifying field 302mc, identifies the stored operation code, and identifies, as a subject instruction 602, another data reference instruction having the identified operation code.

FIG. 6D is a diagram showing the fourth specific example of the second-model ordered data reference instruction 302, the data storage unit 2, and the IO register 2IO.

In a second-model ordered data reference instruction 302d according to the fourth specific example, a subject identifying field 302md is accessed-data region identifying data for identifying a data region accessed by the ordered data reference instruction 302d. Here, for example, the subject identifying field 302md may identify the access location 2P shown in FIG. 5A, or may identify a data region in a neighborhood of the access location 2P, such as the neighboring data region 2N and so on in FIG. 5A, which is made up of the neighborhood of the access location 2P, or may identify a group or an individual register in the IO register 2IO to be accessed.

In the fourth specific example, the subject instruction identifying unit 42 decodes the subject identifying field 302md, identifies the data region, and identifies, as a subject instruction 810, another data reference instruction which accesses such data region. It is to be noted that FIG. 6D also shows an instruction 811 and an instruction 812.

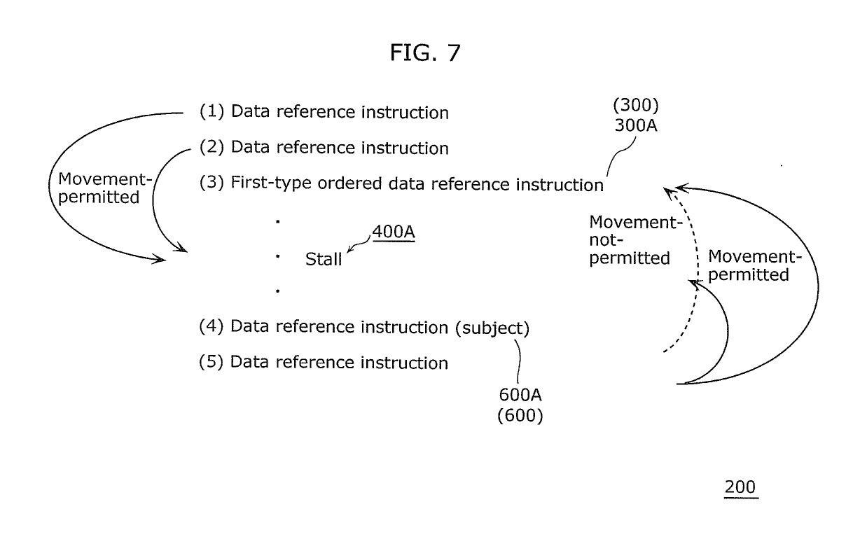

Next, the types of the ordered data reference instruction 300 shall be described with reference to FIG. 7 through FIG. 9.

FIG. 7 is a diagram for describing the program 200 including a first-type ordered data reference instruction 300A.

The first-type ordered data reference instruction 300A is an ordered data reference instruction 300 which specifies a subject instruction 600A, which is the subject of an execution order guarantee, that is inscribed after the first-type ordered data reference instruction 300A in the program 200. For example, the first-type ordered data reference instruction 300A is a data reference instruction which writes in advance data to be read from the data storage unit 2 and the like by the subject instruction 600A which is inscribed after it, and is a data reference instruction which requires the writing to be performed before the reading is started.

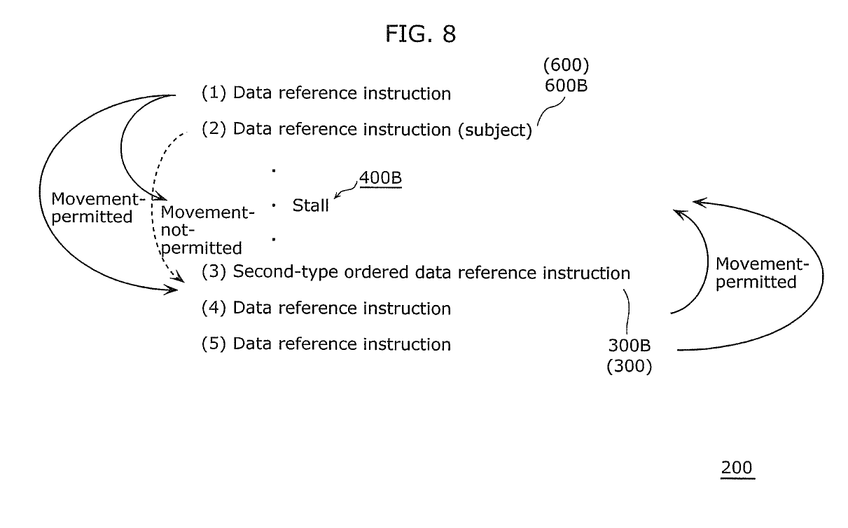

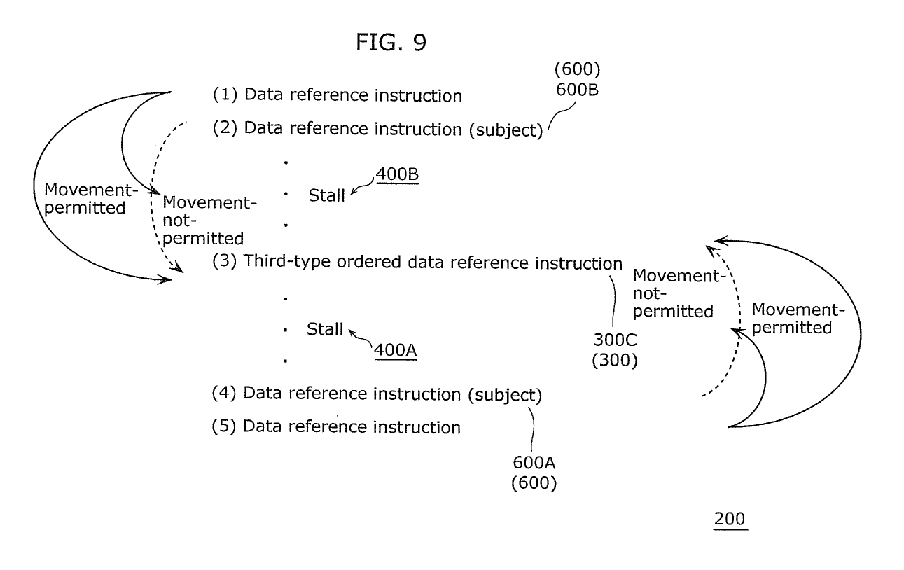

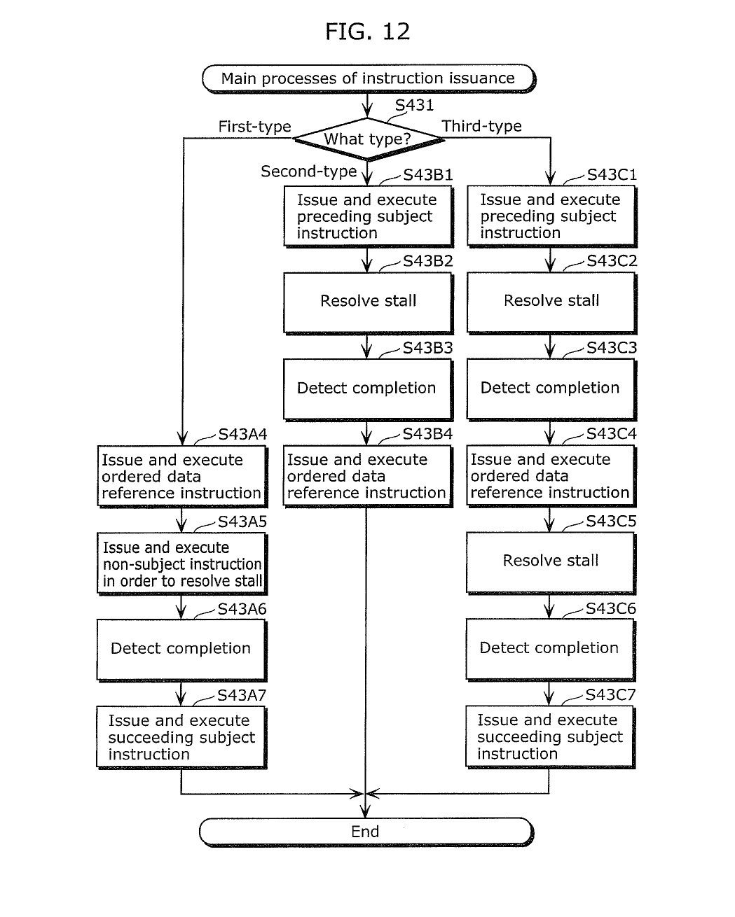

It is to be noted that the movement-not-permitted directional line shown in FIG. 7 denotes that it is guaranteed the movement of the instruction indicated by such directional line will not be performed by the instruction issuing unit 4; and the movement-permitted directional lines shown in FIG. 7 denote that the movement of the instruction indicated by such directional lines are instruction movements that can be freely performed by the instruction issuing unit 4, and do not guarantee that such movements will not be performed. This point is the same with regard to FIG. 8 and FIG. 9. This point shall be described in detail in a subsequent description referring to FIG. 12.

FIG. 8 is a diagram for describing the program 200 including a second-type ordered data reference instruction 300B.

The second-type ordered data reference instruction 300B is an ordered data reference instruction 300 which specifies a subject instruction 600B, which is the subject of an execution order guarantee, that is inscribed ahead of the first-type ordered data reference instruction 300B in the program 200. For example, the second-type ordered data reference instruction 300B is a data reference instruction which reads data written into the data storage unit 2 and the like by the subject instruction 600B which is inscribed ahead of it.

FIG. 9 is a diagram for describing the program 200 including a third-type ordered data reference instruction 300C.

The third-type ordered data reference instruction 300C is an ordered data reference instruction 300 which specifies plural subject instructions 600 which include the subject instruction 600A which is inscribed after the third-type ordered data reference instruction 300C and the subject instruction 600B which is inscribed ahead.

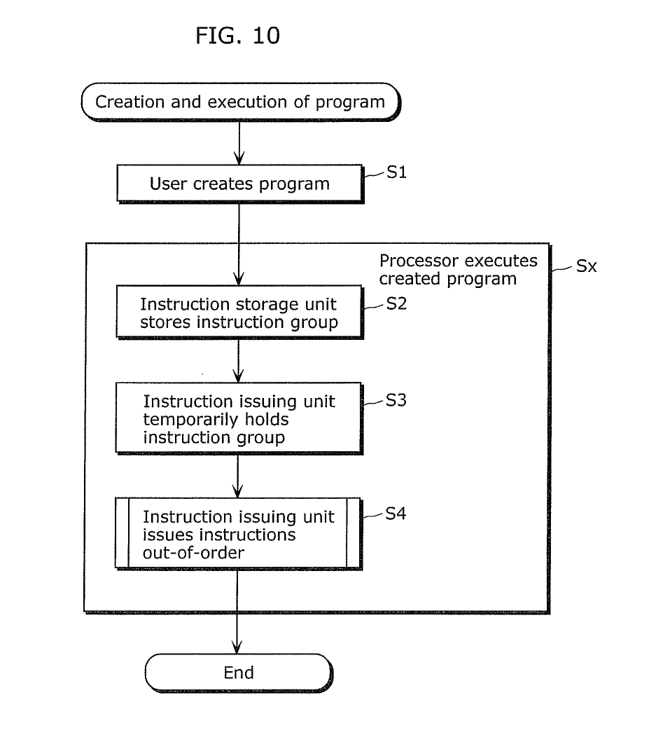

FIG. 10 is a flowchart showing the process in the execution of instructions by the PC 100.

Step S1 is a step in which a user creates the program 200, and is not a process performed by the PC 100.

For example, the user creates the program 200 including the ordered data reference instruction 300, using an assembler. In this case, the program 200 is a program in an assembler language, and the ordered data reference instruction 300 is an instruction in the assembler language. In addition, the user identifies the causal relationships included in the processes to be implemented by the program and the dependence relationships between data, and creates the program 200 by embedding the appropriate ordered data reference instruction 300 in respective locations in the program 200 so as to implement the inter-instruction execution order guarantees that are necessary for the identified relationships. The user, for example, sets an appropriate value in the specification presence display field 301m (FIG. 4B) or in the subject identifying field 302m (FIG. 4C), and thus creates the program 200 including an ordered data reference instruction 300 having a field 300m in which an appropriate value has been set. For example, the user selects a subject instruction 602 which is the subject of an execution order guarantee and writes the storage address of the selected subject instruction 602 in the subject identification field 302m.

It is to be noted that, in step S1, the program 200 may be created by a compiler operated by the user instead of being created by the user.

In this case, for example, the compiler itself may analyze the aforementioned causal relationships and dependence relationships included in a base program which serves as the basis for the program 200, and embed the ordered data reference instruction 300 in respective locations in the program 200 so as to implement the inter-instruction execution order guarantees that are necessary due to causal relationships and so on identified through the analysis.

Here, information for identifying (i) the execution order of instructions that should be guaranteed or (ii) the ordered data reference instruction 300 that should be embedded may be described in the base program by the user using a C-language compiler commander (preprocessor specifier), and the compiler may perform compiling based on the information described by the user. In this case, the compiler may simply embed the ordered data reference instruction 300 identified in the user's description without performing the analysis of the aforementioned causal relationships.

Step Sx is the process in which the PC 100 executes the program 200 created in step S1. The specific details of step Sx are described hereinafter.

In step S2, the instruction storage unit 3 receives and stores the program 200 that is inputted into the processor 1.

In step S3, the instruction storage unit 3 supplies, to the instruction issuing unit 4, an instruction group (execution portion) including the ordered data reference instruction 300 stored in the instruction storage unit 3 in step S2, and the instruction issuing unit 4 temporarily holds the supplied instruction group (execution portion) including the ordered data reference instruction 300.

In step S4, the instruction issuing unit issues, out-of-order, the respective instructions held in step S3 to the executing unit 5, and causes the executing unit 5 to execute the instructions. The executing unit 5 executes the issued respective instructions according to the order of issuance.

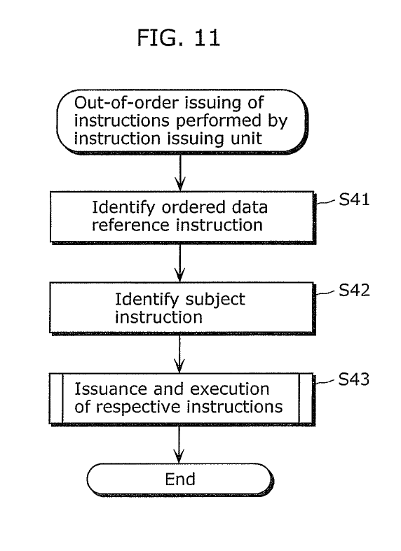

FIG. 11 is a flowchart showing specific details of step S4 in FIG. 10.

In step S41, the field presence judging unit 41 (FIG. 3) judges whether or not the field 300m (FIG. 4A) is included in the respective instructions held by the instruction issuing unit 4 in step S3. By judging that the field 300m is included, the field presence judging unit 41 identifies, as an ordered data reference instruction 300, an instruction that is judged as including such field.

In step S42, the subject instruction identifying unit 42 identifies the subject instruction 600 that is specified by the ordered data reference instruction 300 identified in step S41.

In step S43, the instruction issuance control unit 43 performs the issuance of instructions based on the preparations in the above-described steps S41 to S43.

FIG. 12 is a flowchart showing details of step S43 in the flowchart in FIG. 10.

In step S431, the instruction issuance control unit 43 switches among processing for the first type (steps S43A4 to S43A7), processing for the second type (step S43B1 to S43B4), and processing for the third type (steps S43C1 to S43C7), depending on the type of the ordered data reference instruction 300 (FIG. 7 to FIG. 9).

For example, the executing unit 5 includes a type judging unit which judges the type of the ordered data reference instruction 300. Subsequently, the instruction issuance control unit 43 performs such switching according to the result of the judgment by the type judging unit. The type judging unit judges the type, for example, according to the type of the process identified by the operand included in the main portion 300n of the ordered data reference instruction 300, and judges the type to be the first type when the ordered data reference instruction 300 is an instruction for writing, and judges the type to be the second type when the instruction is for reading, and so on. Alternatively, the type judging unit may read type information which is included in the field 300m and indicates the type, and judge the type indicated by the read type information to be the type of the ordered data reference instruction 300.

In step S43A4, the instruction issuance control unit 43 issues a first-type ordered data reference instruction 300A (instruction (3) in FIG. 7). The instruction issuance control unit 43 issues the first-type ordered data reference instruction 300A in the present step S43A4 ahead of the issuance of a subject instruction 600A (step S43A7).

In step S43A5, in order to resolve a stall 400A (FIG. 7) which occurs because the instruction issuance control unit 43 does not issue a subject instruction 600A until the detection of the completion of the first-type? ordered data reference instruction 300A issued in step S43A4 (see step S43A6 described later), the instruction issuance control unit 43 issues a data reference instruction other than the subject instruction 600A, that is, a non-subject instruction (non-subject instruction 601x in FIG. 4B, and the like).

In FIG. 7, the movement-permitted directional lines indicate that the stall 400A is resolved by having the instruction issuance control unit 43 move a non-subject instruction and issuing the non-subject instruction in the present step S43A5.

In the present step S43A5, even when an instruction is a data reference instruction which, like the subject instruction 600A, is inscribed after the first-type ordered data reference instruction 300A, as with instruction (5) shown in FIG. 7 for example, as long as such instruction is a non-subject instruction other than the subject instruction 600A, the instruction issuance control unit 43 moves such instruction in order to resolve the stall 400A.

It is to be noted that, in the present step S43A5, the instruction issuance control unit 43 resolves the stall 400A by moving an instruction that is not a subject instruction and an instruction that is not a data reference instruction, as long as these are instructions other than the subject instruction 600.

In step S43A6, the instruction issuance control unit 43 detects the completion of the first-type ordered data reference instruction 300A issued in step S43A4.

In step S43A7, the instruction issuance control unit 43 issues the subject instruction 600A identified in step S42 (see FIG. 11), in response to the completion detection in step S44A6. In this manner, the instruction issuance control unit 43 guarantees the execution order of the subject instruction 600A by executing the subject instruction 600A in an execution order within a range that is after the detection of the completion of the execution of the first-type ordered data reference instruction 300A. In FIG. 7, the movement-not-permitted directional lines indicate that the instruction issuance control unit 43 guarantees an execution order in a certain range, and avoids execution in an execution order outside such range.

In step S43B1, the instruction issuance control unit 43 issues the subject instruction 600B (instruction (2) in FIG. 8) specified by the second-type ordered data reference instruction 300B (FIG. 8). The instruction issuance control unit 43 issues the subject instruction 600B in the present step S43B1, ahead of the issuance of the second-type ordered data reference instruction 300B (step S43B4).

In step S43B2, the instruction issuance control unit 43 issues a non-subject instruction in order to resolve a stall 400B (FIG. 8) which occurs because the second-type ordered data reference instruction 300B (see step S43B4) is issued after the detection of the completion of the subject instruction 600B issued in step S43B1 (see step S43B3). In FIG. 8, the movement-permitted directional lines indicate that the stall 400B is resolved by moving of the non-subject instruction and issuing the non-subject instruction in the present step S43B2. Here, even when an instruction is a data reference instruction which, like the subject instruction 600B, is inscribed before the second-type ordered data reference instruction 300B, as with instruction (1) shown in FIG. 8 for example, as long as such instruction is a non-subject instruction, the instruction issuance control unit 43 moves such instruction in order to resolve the stall 400B.

In step S43B3, the instruction issuance control unit 43 detects the completion of the subject instruction 600B issued in step S43B1.

In step S43B4, the instruction issuance control unit 43 issues the second-type ordered data reference instruction 300B in response to the completion detection in step S43B3.

In this manner, the instruction issuance control unit 43 causes the second-type ordered data reference instruction 300B to be executed (step S43B4) in an execution order that is after the completion detection of the subject instruction 600B (step S43B3), and guarantees an execution order for the subject instruction 600B that is in a range of execution orders whose completion detection is ahead of the execution of the second-type ordered data reference instruction 300B.

In step S43C1, the instruction issuance control unit 43 issues the subject instruction 600B (instruction (2)) which is inscribed ahead of the third-type ordered data reference instruction 300C (instruction (3) in FIG. 8), out of the subject instruction 600A and the subject instruction 600B identified in step S42 (FIG. 11).

In step S43C2, the instruction issuance control unit 43 issues a non-subject instruction in order to resolve the stall 400B (FIG. 9) which occurs because the instruction issuance control unit 43 does not issue the third-type ordered data reference instruction 300C (see step S43C4) until the detection of the completion of the subject instruction 600B (see step S43C3). It is to be noted that, at this time, as long as the instruction to be moved is a non-subject instruction, the instruction issuance control unit 43 will move even a non-subject instruction inscribed ahead of the third-type ordered data reference instruction 300C such as the instruction (1) in FIG. 9, and even a non-subject instruction inscribed after the third-type ordered data reference instruction 300C such as the instruction (5) in FIG. 9.

In step S43C3, the instruction issuance control unit 43 detects the completion of the subject instruction 600B which is inscribed ahead and issued in step S43C1.

In step S43C4, the instruction issuance control unit 43 issues the third-type ordered data reference instruction 300C (instruction (3) in FIG. 9) in response to the completion detection in step S43C3.

In step S43C5, the instruction issuance control unit 43 issues a non-subject instruction so as to resolve the stall 400A occurring up to the detection of the completion (see step S43C6) of the third-type ordered data reference instruction 300C issued in step S43C4. It is to be noted that, at this time too, the instruction issuance control unit 43 moves even a data reference instruction inscribed ahead of the third-type ordered data reference instruction 300C and a data reference instruction inscribed after the third-type ordered data reference instruction 300C.

In step S43C6, the instruction issuance control unit 43 detects the completion of the third-type ordered data reference instruction 300C (instruction (3) in FIG. 8) issued in step S43C4.

In step S43C7, the instruction issuance control unit 43 issues the subject instruction 600B (instruction (4) in FIG. 8) inscribed after, out of the subject instructions identified in the preceding step S42 (see FIG. 11), in response to the completion detection in step S43C6.

In this manner, the instruction issuance control unit 43 guarantees the execution orders of the subject instruction 600A and the subject instruction 600B by causing the subject instruction 600B to be executed ahead of the third-type ordered data reference instruction 300C (step S43C1) and issuing the third-type ordered data reference instruction 300C (step S43C4) in an execution order that is after the detection of completion of the third-type ordered data reference instruction 300C (step S43C3), and in addition issuing the subject instruction 600A (step S43A7) in an execution order that is after the detection of completion of the third-type ordered data reference instruction 300C (step S43C6).

In this manner, the present embodiment utilizes an instruction execution control method which is a method of controlling the execution of an instruction by the processor 1 in which a process of “judging whether or not a predetermined field 300m is included in a data reference instruction” is performed by the field presence judging unit 41, a process of “decoding the field 300m of the ordered data reference instruction 300 that was judged to include the field 300m in the above-described process, and identifying a subject instruction 600, which is the subject of an execution order guarantee, specified by the ordered data reference instruction 300” is performed by the subject instruction identifying unit 42, and a process of “controlling the execution order of the two instructions so that, in causing the execution of the ordered data reference instruction 300 and the identified subject instruction 600, the execution order of the identified subject instruction 600 with respect to the execution of the ordered data reference instruction 300 is guaranteed” is performed by the instruction issuance control unit 43.

Furthermore, the present embodiment utilizes a method in which a process of “decoding the field 300m of the ordered data reference instruction 300 (first-type ordered data reference instruction 300A, second-type ordered data reference instruction 300B) that was judged to include such field, and identifying a subject instruction 600A which is specified by the ordered data reference instruction 300, inscribed after the ordered data reference instruction 300, and is the subject of an execution order guarantee” is performed by the subject instruction identifying unit 42, and a process of “causing the execution of the identified subject instruction 600A in an execution order that is after the completion of the execution of the ordered data reference instruction 300” is performed by the instruction issuance control unit 43.

Furthermore, the present embodiment utilizes a method in which a process of “decoding the field 300m of the ordered data reference instruction 300 (second-type ordered data reference Is instruction 300B, third-type ordered data reference instruction 300C) that was judged to include such field, and identifying a subject instruction 600B which is specified by the ordered data reference instruction 300, inscribed before the ordered data reference instruction 300, and is the subject of an execution order guarantee” is performed by the subject instruction identifying unit 42, and a process of “causing the execution of the identified subject instruction 600B in an execution order whose execution completion is ahead of the execution of the ordered data reference instruction 300” is performed by the instruction issuance control unit 43.

According to such an embodiment, since it is possible to separately specify the subject instruction 600 which is to be the subject of an execution order guarantee, the instruction for which movement is not permitted during out-of-order execution becomes only the specified subject instruction 600, and by reducing the instructions for which movement is to be restricted, instructions can be moved more freely, and thus, for example, the instruction (1) inscribed ahead in FIG. 8 can be moved freely and thus the stall 400A and the like can be sufficiently minimized thereby enabling the speed of the processor 1 to be increased.

In addition, a method where, in the case of FIG. 4A, specifically, when the ordered data reference instruction 300 is the first-model ordered data reference instruction 301, the field 300m is a specification presence display field 301m indicating whether or not the first-model ordered data reference instruction 301 specifies a subject instruction 601; and in the case where it is indicated that the first-model ordered data reference instruction 301 specifies a subject instruction 601 in the process in which the instruction is identified, another data reference instruction which has as an access destination a resource 700 that is the same as the resource 700 which is the access destination of the first-model ordered data reference instruction 301 is identified as the subject instruction 601.

Furthermore, in the case of the third specific example among the specific examples described in FIG. 5A, in the process in which the subject instruction is identified, only the other data reference instruction 801 accessing an access location 2P that is the same as the access location 2P which is the access destination of the first-model ordered data reference instruction 301a, among the respective data regions of the resource 700 which is the access destination of the first-model ordered data reference instruction 301a, is identified as the subject instruction 601.

Furthermore, in the case of the first specific example in FIG. 5A, the other data reference instruction 801 accessing the neighboring data region 2N in a predetermined neighborhood including the access location 2P accessed by the first-model ordered data reference instruction 301, out of the respective data regions of the resource 700 which is the access destination of the first-model ordered data reference instruction 301, is identified as the subject instruction 601.

It is to be noted that, in the case of the second specific example in FIG. 5A, the other data reference instruction 801 accessing the group including the individual register accessed by the first-model ordered data reference instruction 301, out of the respective individual registers of the resource 700 which is the access destination of the first-model ordered data reference instruction 301, is identified as the subject instruction 601.

Furthermore, in the case of the fourth specific example shown in FIG. 5B, when the first-model ordered data reference instruction 301 identifies an access location to be accessed from among respective data regions of the resource 700 according to the register indirect mode in the process in which the subject instruction is identified, a data reference instruction which has the resource 700 as an access destination and accesses any of the data regions is identified as the subject instruction 601.

Furthermore, in the case of FIG. 4B, the field 300m is a subject identification field 302m identifying the subject instruction 602 and, in the process in which the subject instruction is identified, the subject identification field 302m is decoded so that the data reference instruction identified by the subject identification field 302m is identified as the subject instruction 602.

In addition, as an instruction format of the first-type ordered data reference instruction 301, there is utilized an instruction format 301f which includes the main portion 300n identifying the resource 700 which is the access destination in the resource access of the first-type ordered data reference instruction 301 and the specification presence display field 301m indicating whether or not the first-type ordered data reference instruction 301 is an ordered data reference instruction which causes the execution order of another data reference instruction to be guaranteed.

Furthermore, as an instruction format of the second-type ordered data reference instruction 302, there is utilized an instruction format 302f which includes a subject identification field 302m identifying a data reference instruction which is the subject of the execution order guarantee in which the second-type ordered data reference instruction 302 causes the guaranteeing of an execution order that is relative to the second-type ordered data reference instruction 302.

In addition, in the case of FIG. 6A, by specifying one or plural address spaces (address, storage address), the subject identification field 302m identifies, as a data reference instruction that is a guarantee subject (subject instruction 602), the respective data reference instructions stored in the region of each of the address spaces.

It is to be noted that, in the case of FIG. 6D, by specifying one or plural address spaces (access data region identification data), the subject identification field 302m identifies, as a data reference instruction that is a guarantee subject (subject instruction 602), the respective data reference instructions stored in the region identified by each of the access data region identification data.

Furthermore, in the case of FIG. 6B, by specifying operands included in one or plural data reference instructions (ordered data reference instruction 302c), the subject identifying field 302m identifies, as a subject instruction 602, another data reference instruction which accesses a data region (access location 2Pb) that is the same as the data region (access location 2Pb) identified by each of the operands.

Hereinafter, a modification shall be described.

Although the instruction issuing unit which is provided in the processor 1 and performs the movement of instructions in the out-of-order issuance of instructions is described in the aforementioned embodiment, the above-described technology of the instruction issuing unit may be applied to an optimization processing unit which is provided in a compiler and moves instructions in order to perform the optimization of a program. In this case, such compiler is a compiler which converts the program 200 in which the ordered data reference instruction 300 is included into an output program that is different from the program 200. In addition, the optimization processing unit moves the order of the instructions included in the program 200, for the purpose of optimization, and during this movement, identifies the subject instruction and guarantees the order of the subject instruction in the output program to a certain range, in the same manner as the above-described instruction issuing unit. At this time, the optimization processing unit performs optimization sufficiently by guaranteeing only the specified subject instruction and freely moving a non-subject instruction which is not the subject instruction.

Accordingly, at the time of the optimization of the compiler, the instructions that cannot be moved are only the small number that are specified, and by reducing the instructions for which movement is to be restricted, it is possible to more freely move instructions so that the output program that is outputted by the compiler is executed at high speed.

It is to be noted that, in this case, the optimization processing unit may output, as an output program after the order of instructions have been moved, an output program in which an ordered data reference instruction is included in at least a part thereof.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

Compared to the conventional art, the instruction execution control method, the processor using such method, and the instruction format according to the present invention minimize the instructions that cannot be moved at the time of out-of-order execution, and thus have an advantageous effect of being able to sufficiently reduce stalling and suppress performance deterioration particularly in the case of performing data transfer to a resource having high access latency and so on, and are thus useful in a processor, and system provided with a processor, which requires queuing with another processor or requiring reading of an IO register after writing of another IO register is completed, in the case where exchange of data is performed between the processor and a memory or IO register outside the processor.

What is claimed is:

1. An instruction execution control method of controlling execution of an instruction by a processor, said method comprising:
judging whether or not a field, which is predetermined, is included in a first data reference instruction;
identifying a second data reference instruction specified by the first data reference instruction and which is to be a subject of an execution order guarantee, by decoding the field of the first data reference instruction that is judged to include the field in said judging; and
controlling an execution order of the first data reference instruction and the second data reference instruction during execution of the first data reference instruction and the second data reference instruction, so as to guarantee the execution order of the identified second data reference instruction with respect to the execution of the first data reference instruction.

2. The instruction execution control method according to claim 1,
wherein, in said identifying, a second data reference instruction inscribed after the first data reference instruction and specified by the first data reference instruction is identified by decoding the field of the first data reference instruction that is judged to include the field in said judging, the second data reference instruction being the subject of the execution order guarantee, and
in said controlling, the second data reference instruction identified is caused to be executed in an execution order that is after completion of the execution of the first data reference instruction.

3. The instruction execution control method according to claim 1,
wherein, in said identifying, a second data reference instruction inscribed ahead of the first data reference instruction and specified by the first data reference instruction is identified by decoding the field of the first data reference instruction that is judged to include the field in said judging, the second data reference instruction being the subject of the execution order guarantee, and
in said controlling, the second data reference instruction identified is caused to be executed in an execution order in which completion of execution of the second data reference instruction is ahead of the execution of the first data reference instruction.

4. The instruction execution control method according to claim 1,
wherein in said identifying, a second data reference instruction inscribed after the first data reference instruction and a second data reference instruction inscribed ahead of the first data reference instruction which are specified by the first data instruction are identified by decoding the field of the first data reference instruction that is judged to include the field in said judging, each of the second data reference instructions being the subject of the execution order guarantee, and
in said controlling, the identified second data reference instruction that is inscribed after the first data reference instruction is caused to be executed in an execution order that is after completion of the execution of the first data reference instruction, and the identified second data reference instruction that is inscribed ahead of the first data reference instruction is caused to be executed in an execution order in which completion of execution of the second data reference instruction is ahead of the execution of the first data reference instruction.

5. The instruction execution control method according to claim 4,
wherein the field indicates whether or not the first data reference instruction specifies the second data reference instruction, and
in said identifying, when the specifying is indicated, another data reference instruction whose access destination is a same resource as a resource which is an access destination of the first data reference instruction is identified as the second data reference instruction specified.

6. The instruction execution control method according to claim 5,
wherein in said identifying, only a data reference instruction which accesses a same data region as a data region that is accessed by the first data reference instruction among data regions of the resource which is the access destination of the first data reference instruction is identified as the second data reference instruction.

7. The instruction execution control method according to claim 5,
wherein in said identifying, a data reference instruction which accesses a data region of a predetermined neighborhood including a data region that is accessed by the first data reference instruction among data regions of the resource which is the access destination of the first data reference instruction is identified as the second data reference instruction.

8. The instruction execution control method according to claim 7,
wherein in said identifying, when the first data reference instruction identifies a data region to be accessed from among the data regions of the resource according to register indirect mode, a data reference instruction accessing any of the data regions is identified as the second data reference instruction.

9. The instruction execution control method according to claim 2,
wherein the field identifies a data reference instruction, and
in said identifying, the data reference instruction identified by the field is identified as the second data reference instruction by decoding the field.

10. A non-transitory computer-readable recording medium on which a data reference instruction is recorded,
wherein the data reference instruction includes:
an instruction main portion which identifies a resource that is an access destination of the data reference instruction; and
a field which indicates whether or not the data reference instruction is an ordered data reference instruction that causes an execution order of another data reference instruction to be guaranteed.

11. A non-transitory computer-readable recording medium on which a data reference instruction is recorded,
wherein the data reference instruction includes a field which identifies a subject data reference instruction for which a relative execution order with respect to the data reference instruction is guaranteed, the guarantee being caused by the data reference instruction.

12. The non-transitory computer-readable recording medium according to claim 11,
wherein the field specifies one or more address spaces so as to identify, as the subject data reference instruction, a data reference instruction stored in a region of each of the one or more address spaces.

13. The non-transitory computer-readable recording medium according to claim 11,
wherein the field specifies one or more operands included in the data reference instruction, so as to identify, as the subject data reference instruction, another data reference instruction which accesses a same data region as a data region identified by each of the one or more operands.

14. The non-transitory computer-readable recording medium according to claim 11,
wherein the field specifies one or more instruction types so as to identify, as the subject data reference instruction, a data reference instruction of each of the instruction types specified.

15. A processor which executes an instruction, said processor comprising:
a field judging unit configured to judge whether or not a predetermined field is included in a first data reference instruction;
an instruction identifying unit configured to identify a second data reference instruction inscribed after the first data reference instruction and specified by the first data reference instruction, by decoding the field of the first data reference instruction that is judged to include the field by said field judging unit, the second data reference instruction being a subject of an execution order guarantee; and
an execution control unit configured to cause the identified second data reference instruction to be executed in an execution order that is after completion of execution of the first data reference instruction.

16. A processor which executes an instruction, said processor comprising:
a field judging unit configured to judge whether or not a predetermined field is included in a first data reference instruction;
an instruction identifying unit configured to identify a second data reference instruction inscribed ahead of the first data reference instruction and specified by the first data reference instruction, by decoding the field of the first data reference instruction that is judged to include the field by said field judging unit, the second data reference instruction being a subject of an execution order guarantee; and
an execution control unit configured to cause the identified second data reference instruction to be executed in an execution order in which completion of execution of the second data reference instruction is ahead of the execution of the first data reference instruction.

17. A processor which executes an instruction, said processor comprising:
a field judging unit configured to judge whether or not a predetermined field is included in a first data reference instruction;
an instruction identifying unit configured to identify a second data reference instruction inscribed after the first data reference instruction and a second data reference instruction inscribed ahead of the first data reference instruction which are specified by the first data instruction, by decoding the field of the first data reference instruction that is judged to include the field by said judging unit, each of the second data reference instructions being the subject of the execution order guarantee, and
an execution control unit configured to cause the identified second data reference instruction that is inscribed after the first data reference instruction to be executed in an execution order that is after completion of the execution of the first data reference instruction, and to cause the identified second data reference instruction that is inscribed ahead of the first data reference instruction to be executed in an execution order in which completion of execution of the second data reference instruction is ahead of the execution of the first data reference instruction.
